(19) United States
(12) Patent Application Publication
(10) Pub. No.: US 2021/0247126 A1
(43) Pub. Date: Aug. 12, 2021

(54) Phase Change Barriers and Methods of Use Thereof

(71) Applicant: Nelumbo Inc., Hayward, CA (US)

(72) Inventors: Lance R. Brockway, Hayward, CA (US); David C. Walther, Hayward, CA (US)

(21) Appl. No.: 17/054,058

(22) PCT Filed: May 9, 2019
(86) PCT No.: PCT/US2019/031626

§ 371 Date: Nov. 9, 2020

Related U.S. Application Data
(60) Provisional application No. 62/669,507, filed on May 10, 2018.

(51) Int. Cl. F25D 21/04; C09D 5/03; F24F 13/22; F28F 13/04

(52) U.S. Cl. CPC F25D 21/04; C09D 5/032; F28F 2260/02; F28F 13/04; F24F 13/22

(57) ABSTRACT

Modified surfaces and methods of use thereof are provided for preventing or delaying onset of phase changes, such as condensation or frost formation. The invention relates to surfaces that increase the energy barrier to or driving force required for nucleation phase changes, such as, but not limited to, condensation and crystallization, and methods of use thereof, such as anti-fog glass applications and prevention of condensation on heat exchangers in systems that only require sensible cooling.

### CROSS-REFERENCE TO RELATED APPLICATIONS

This application claims the benefit of U.S. Provisional Application No. 62/669,507, filed on May 10, 2018, which is incorporated by reference herein in its entirety.

### FIELD OF THE INVENTION

The invention relates to surfaces that increase the energy barrier to or driving force required for nucleation phase changes, such as, but not limited to, condensation and crystallization, and methods of use thereof, such as anti-fog glass applications and prevention of condensation on heat exchangers in systems that only require sensible cooling.

### BACKGROUND

Typical condensation on low energy surfaces does not result in round droplets upon nucleation, but instead water and other condensates will condense in a stressed, lower contact angle state. The difference in the contact area in nucleation via a wetted state, relative to a dewetted state, can shift the energy barrier of droplet formation (i.e., modify the energy barrier of the condensation process). Typical surfaces will condense water out of the air at the dewpoint. Often, condensation is undesirable on surfaces where electronics are located, such as computers or data centers that utilize subambient cooling, or on glass surfaces where visibility is desired, such as windows, lenses, and mirrors.

Solutions for preventing condensate from heat transfer surfaces usually require keeping the coolant temperature significantly above the dew point, which can cause decreases in heat transfer capacity and limit operating ranges. Often the coolant temperature is lowered to the minimum amount allowed for by the system control, to prevent condensation while maintaining the capacity as high as possible. In the event of a control or input error to the system, there is a risk of water condensing on the surfaces and potentially destroying the electronics. A solution is needed to allow for the lowest coolant temperature possible to maximize heat transfer, while allowing for the largest differential between the coolant temperature and the effective onset of condensation. Currently this onset of condensation is the dew point.

The condensation and fogging of glass windows and mirrors is also a problem, such as shower mirrors, automotive glass, and building windows. Typical solutions currently involve using a towel or squeegee to wipe away the condensate or using hydrophilic coatings to spread out the condensate into a thin film so that one can still see through the window or see their reflection in the mirror. These hydrophilic coatings are problematic in that they allow for accelerated condensation and the deposition of contaminants onto the surface, resulting in more frequent cleanings.

According to classical nucleation theory, the free energy of homogeneous nucleation is defined as a volume term plus a surface term, ΔGₕₒₘₒ=4/3(πr³)Δg+4 πr²σ, where r is the radius of a sphere of the forming phase, Δg is the free energy per unit volume of the supersaturated phase minus the free energy of the nucleated phase, and σ is the surface tension of the interface between the nucleus and its surroundings. The critical radius of formation, r*, with a free energy barrier of ΔGₕₒₘₒ*, can be calculated by taking d(ΔGₕₒₘₒ)/dr=0. The radius at which this derivative is zero corresponds to r*=−2σ/Δg. The free energy of homogeneous nucleation can then be defined as ΔGₕₒₘₒ*=ΔGₕₒₘₒ (r*)=16πσ³(3(Δg)²). Heterogeneous nucleation has a lower energy barrier that can be determined for a vapor to liquid phase change as a function of the contact angle (θ) on the surface. This relationship can be approximated as ΔGₕₑₜₑᵣₒ*=f(θ) ΔGₕₒₘₒ*, where f(θ)=(2−3 cos θ+cos³ θ)/4.

Similar to the vapor to liquid transition, in many applications it is desirable to increase the barrier of phase transition from liquid to solid, such as on heat exchanger surfaces for refrigerators or freezers, ranging in size from small dorm room units to those at industrial scale distribution centers. Ice is a problem for these heat transfer systems, as it requires the system to be periodically shut down for defrosts, which decrease throughput for industrial applications and consume large amounts of energy. Additionally, defroster units are expensive at the large scale.

Icing is also a problem on airfoil surfaces, such as those on airplane wings and windmills. Ice on airplane wings is dangerous for flight and must be removed before takeoff, resulting in costly delays. Windmills can accumulate ice, which causes outputted power to significantly drop and creates a safety risk of ice launching from the blade surfaces.

### BRIEF SUMMARY OF THE INVENTION

Methods for reducing (e.g., preventing or delaying) condensation of a gas (e.g., vapor) phase below the gas to liquid transition temperature (e.g., dew point) or reducing (e.g., preventing or delaying) solidification (e.g., freezing) of a liquid phase, and systems, equipment, and compositions for performing the methods or on which the methods are effected are provided herein.

In one aspect, methods are provided herein for preventing or delaying the onset of a phase change on a surface. The methods include providing a modified surface that increases the energy barrier to a phase change or driving force required for a phase change from a first phase to a second phase, in comparison to an unmodified surface; and contacting a fluid stream with the modified surface under environmental conditions at which the phase change would occur on the unmodified surface, wherein said phase change is prevented or delayed in comparison to the unmodified surface. In one embodiment, a method for preventing or delaying the onset of a phase change incudes: providing a modified surface that includes a surface modification, wherein the modified surface increases the energy barrier to a phase change or the driving force required for a phase change from a first phase to a second phase for a substance that is in contact with the modified surface, in comparison to an unmodified surface that is identical to the modified surface with the exception that the unmodified surface does not include the surface modification; and contacting a fluid stream that includes a substance in at least one first phase (e.g., gas (e.g., vapor) and/or liquid phase) with the modified surface under environmental conditions at which phase change to a second phase (e.g., gas to liquid; liquid to solid; gas to solid) would occur on the unmodified surface, wherein the phase change from first to second phase is prevented or delayed on the modified surface in comparison to the unmodified surface.

In some embodiments, the at least one first phase includes a gas (e.g., vapor) phase, the second phase includes a liquid phase, and the prevention or delay of phase change includes prevention or delay of condensation of the gas (e.g., vapor) to form a liquid on the surface. In one embodiment, the gas phase is water vapor, the fluid stream is air, and the prevention or delay of phase change includes prevention or delay of condensation of the water vapor on the surface.

In some embodiments, the at least one first phase includes a gas (e.g., vapor) phase, the second phase includes a solid phase, the gas (e.g., vapor) condenses on the surface to form a liquid (e.g., condensate), and the prevention or delay of phase change includes prevention or delay of solidification of the liquid (e.g., condensate) to form a solid on the surface. In one embodiment, the gas phase is water vapor, the fluid stream is air, the liquid phase is water condensate, and the prevention or delay of phase change includes prevention or delay of solidification of the water condensate to form water frost or ice on the surface.

In some embodiments, the at least one first phase includes a gas (e.g., vapor) phase and a liquid phase, the second phase includes a liquid phase, and the prevention or delay of phase change includes prevention or delay of condensation of the gas (e.g., vapor) to form a liquid on the surface. In one embodiment, the gas phase is water vapor, the liquid phase is liquid water, the fluid stream is air, and the prevention or delay of phase change includes prevention or delay of condensation the water vapor on the surface.

In some embodiments, the at least one first phase includes a gas (e.g., vapor) phase and a liquid phase, the second phase includes a solid phase, the surface includes condensate from the gas (e.g., vapor) and/or includes liquid of the substance, and the prevention or delay of phase change includes prevention or delay of solidification of said the condensate and/or the liquid to form a solid on the surface. In one embodiment, the gas phase is water vapor, the liquid phase and the liquid on the surface is water, the fluid stream is air, the surface includes condensate of the water vapor and/or liquid water, and the prevention or delay of phase change includes prevention or delay of solidification of the water condensate and/or liquid water on the surface to form water frost or ice on the surface.

In some embodiments, the at least one first phase includes a gas (e.g., vapor) phase, the second phase includes a solid phase, and prevention or delay of phase change includes prevention or delay of solidification of the gas (e.g., vapor) to form a solid on the surface. In one embodiment, the gas phase is water vapor, the solid is water frost or ice, and the prevention or delay of phase change includes prevention or delay of solidification of the water vapor to form water frost or ice on the surface. In one embodiment, the gas phase includes or is CO₂ gas, the solid is frozen CO₂ (CO₂ dry ice), and the prevention or delay of phase change includes prevention or delay of solidification of the CO₂ gas to form CO₂ dry ice on the surface.

In some embodiments, the modified surface is subcooled below the equilibrium phase transition value (e.g., temperature) of the first phase to the second phase (e.g., gas (e.g., vapor) to liquid; gas (e.g., vapor) to solid; liquid to solid transition), and the substance still exists as the first phase. In various embodiments, the modified surface is subcooled by greater than any of about 0.25, 0.5, 1, 2, 3, 5, or 10° C. below the equilibrium phase transition value of the first phase to the second phase, and the substance still exists as the first phase.

In various embodiments, the energy barrier to phase change from the first phase to the second phase is greater than any of about 50, 60, 70, 80, 90, 95, or 99% of the homogeneous nucleation energy.

In some embodiments, the phase change from the first phase to the second phase includes nucleation of the substance on the modified surface. The modified surface or surface coating where nucleation occurs may be, for example, a barrier coating, a conversion coating, or a combination thereof. In some embodiments, the modified surface or surface coating where nucleation occurs is nanostructured. In some embodiments, the modified surface or surface coating where nucleation occurs includes a metal oxide, e.g., a metal oxide layer created through deposition or conversion, or a polymer, e.g., a polymer containing alkyl or fluoroalkyl monomer units. In some embodiments, the modified surface or surface coating includes terminal alkyl or fluorinated compound(s).

In some embodiments, the first phase includes primarily water vapor and the second phase includes liquid water or water ice. In some embodiments, the first phase is air that includes water vapor and the second phase is liquid water or water ice. In some embodiments, the first phase is liquid water and the second phase is water ice. In some embodiments, first phase includes carbon dioxide vapor and the second phase is dry ice or solid CO₂.

In some embodiments, the first phase includes gas vapor and the second phase includes a clathrate. For example, the substance may be raw natural gas, the first phase includes a gas (e.g., vapor) phase, and the second phase includes a clathrate. In one embodiment, the first phase is a gas (e.g., vapor) or liquid, and the second phase is a supercritical phase.

In some embodiments, the substance is a metal, the first phase includes metal vapor and the second phase includes condensed metal vapor.

In some embodiments, a condensed droplet of the fluid at or above the critical radius of formation exists in a dewetted Cassie-Baxter state. In some embodiments, a condensed droplet of the fluid at or above the critical radius of formation exists in a dewetted Cassie-Baxter state, having previously existed in a wetted Wenzel state.

In some embodiments, the modified surface is on a heat exchanger or heat transfer surface.

In some embodiments, the modified surface is on a glass, window, mirror, or lens surface.

In some embodiments, the modified surface is in a pattern on a glass component such that condensation occurs in an aesthetically pleasing or functionally desirable manner.

In some embodiments, the modified surface is on a computer case or cooling rack. In some embodiments, the modified surface is on a gas vaporizer, for example, on a gas vaporizer heat exchanger. In some embodiments, the modified surface is in a vaporizer device, and the modified surface prevents or reduces fouling in the form of condensation on the vaporizer device.

In some embodiments, the modified surface is in an engine or combustion nozzle, for example, wherein the modified surface prevents or reduces carbon dioxide condensation in the engine or combustion nozzle.

In some embodiments, the modified surface is on processing equipment for industrial gases and/or liquids, for example, wherein the modified surface prevents or reduces water and gas hydrate and/or clathrate formation during the processing of industrial gases and liquids in the process equipment. In one embodiment, the substance is raw natural gas, and the phase change includes hydration or host-guest complexing (e.g., formation of solid materials). In some embodiments, the first phase is a gas (e.g., vapor) or liquid and the second phase is a supercritical phase.

In some embodiments, the modified surface is on metal vapor lighting or advanced lithography equipment, for example, wherein the modified surface prevents or reduces metal vapor condensation during operation of the metal vapor lighting or advanced lithography equipment. In an embodiment, uniformity and prevention of deposition is critical to precise operation of the advanced lithography equipment.

In another aspect, a heat exchanger or heat transfer surface is provided that includes a modified surface as described herein that increases the energy barrier to or driving force required for a phase change from a first phase to a second phase, in comparison to an unmodified surface, wherein the onset of the phase change is prevented or delayed in the heat exchanger or heat transfer surface in comparison to a heat exchanger or heat transfer surface that does not include the modified surface.

In another aspect, a glass, window, mirror, or lens is provided that includes a modified surface as described herein that increases the energy barrier to or driving force required for a phase change from a first phase to a second phase in comparison to an unmodified surface, wherein the onset of the phase change is prevented or delayed on the glass, window, mirror, or lens, in comparison to a glass, window, mirror, or lens that does not include the modified surface.

In another aspect, a glass component is provided that includes a patterned modified surface as described herein that increases the energy barrier to or driving force required for a phase change from a first phase to a second phase in comparison to an unmodified surface, wherein the onset of the phase change is prevented or delayed on the modified surface in comparison to the unmodified surface. For example, the patterning may provide a decorative and/or functionally desirable pattern on the glass such that condensation occurs in an aesthetically pleasing and/or functional manner.

In another aspect, a computer case or cooling rack is provided that includes a modified surface as described herein that increases the energy barrier to or driving force required for a phase change from a first phase to a second phase in comparison to an unmodified surface, wherein the onset of the phase change is prevented or delayed on the computer case or cooling rack, in comparison to a computer case or cooling rack that does not include the modified surface. For example, the modified surface may prevent or reduce condensation related damage to electronics or computer equipment housed therein.

In another aspect, a gas vaporizer is provided that includes a modified surface as described herein that increases the energy barrier to or driving force required for a phase change from a first phase to a second phase in comparison to an unmodified surface, wherein the onset of the phase change is prevented or delayed on the gas vaporizer, in comparison to a gas vaporizer that does not include the modified surface. For example, the modified surface may prevent or reduce condensation and/or frost on a vaporizer heat exchanger therein.

### BRIEF DESCRIPTION OF THE DRAWINGS

FIGS. 1A-1B show phase change of water on surface modified and unmodified aluminum plates, as described in Example 1.

FIG. 2 shows the results of ice formation in surface modified and unmodified heat exchangers, in the experiment described in Example 2.

FIG. 3 schematically shows a closed-loop air conditioner system, as described in Example 3.

FIG. 4 shows the results of adding a condensation nucleation barrier to a heat exchanger, as described in Example 3.

FIGS. 5A-5E show a time progression of liquid to solid phase change of water on an unmodified surface and a modified surface, as described in Example 4.

FIG. 6 shows a plot of ice thickness versus time for an unmodified surface and a modified surface in an environmental chamber with controlled air velocity and surface temperature, as described in Example 5.

FIG. 7 shows the air-side pressure drop of a modified versus unmodified heat exchanger, as described in Example 6.

### DETAILED DESCRIPTION

The ability to condense droplets in a high contact angle, round state lowers the effective onset temperature of condensation below the bulk dew point via an increased energy barrier of drop formation. Modified surfaces and methods are provided herein that prevent or delay onset of condensation or frost formation under particular environmental conditions, e.g., temperature and/or relative humidity, by increasing the energy barrier to nucleation phase changes. The materials and methods of use described herein are applicable to systems in which condensation and/or ice formation are undesirable. Further, methods are provided for increasing safety in particular applications or enhancing the range of environmental conditions for safe or effective operation of such systems. Methods are also provided for improvement of performance of by delaying or removing the need to defrost or dry out such systems.

Other phase change phenomena which are addressed by the materials and methods described herein include the formation of solid carbon dioxide from CO₂ systems, the formation of clathrate hydrates, e.g., in deep water exploration systems, and the condensation of vapor phase compounds in vaporizing systems. Systems operating in both sub- and supercritical operating conditions are also addressed.

In some embodiments, a system such as a heat exchanger can operate at a lower temperature or handle larger temperature variance without condensation occurring, in comparison to an identical system that does not include a surface modification as described herein. In some embodiments, nucleation can be suppressed at a supercool (difference between dew point and surface temperature) of >5° C.

In some embodiments, the surface modification includes a nanostructured composition.

### Definitions

Numeric ranges provided herein are inclusive of the numbers defining the range.

“A,” “an” and “the” include plural references unless the context clearly dictates otherwise.

“Equilibrium phase transition value” is the temperature/pressure conditions at which phase change thermodynamically would occur with no energy barrier. This phase change can either be a transition at the dew point (e.g., condensation), at the frost point (e.g., frosting), or at the freezing point (e.g., crystallization) and occurs when the transitioning phase becomes saturated. “Frost point” refers to formation of a lower density solid water phase, and “freezing point” refers formation of ice at close to the complete density. Typically for water, frost looks white and powdery like snow and freezing/ice is more dense, optically transparent ice.

“Homogenous nucleation energy” refers to the energy barrier for nucleation as defined by classical nucleation theory, ΔGₕₒₘₒ*.

“Dew point” is the temperature for a given set of environmental pressure and humidity conditions at which the liquid water phase is energetically more favorable than the vapor phase. This is the point at which condensation will occur absent of an energy barrier.

“Contact angle” is the angle measured through the liquid between the surface and the liquid-vapor interface at the contacting surface.

“Free surface energy” refers to the energy of an interface (liquid-vapor, solid-liquid, or vapor-solid). High energy surfaces more easily wet than low energy surfaces.

A “barrier coating” forms a physical barrier, thus minimizing contact with undesired elements (e.g., water (as a “moisture barrier”); electrolytes (as a “corrosion barrier”).

A “conversion coating” refers to a surface layer in which reactants are chemically reacted with the surface to be treated.

A “nanostructured” coating refers to a coating composition that has a feature in at least one dimension that is less than 100 nanometers.

“Condensing conditions” refers to a condition wherein a surface is cooled below the dew point of a vapor.

“Sensible heat” refers to the amount of heat due to a change in temperature of a gas or object with no change in phase.

“Sensible cooling capacity” refers to the amount of heat which can be transferred to a material in the absence of phase change.

“Latent heat” refers to the amount of energy (e.g., heat) required to change a phase (for example, a solid to or from a liquid or gas phase; or a liquid to or from a gas phase) without a change in temperature.

“Latent cooling capacity” refers to the amount of energy (e.g., heat) which can be transferred to or from a material due to a phase change.

“Sensible heat ratio” refers to the ratio of sensible cooling capacity to total cooling capacity. The total cooling capacity is often a sum of the sensible cooling capacity and latent cooling capacity.

A “Cassie-Baxter state” refers to the formation of a state in which a drop rests on top of a textured surface in which a hybrid interface exists. typically in the form of a gas phase trapped beneath the surface of the drop.

A “Wenzel state” refers to the formation of a state in which an amount of liquid is in contact with a textured surface in which the liquid has wetted the underlying surface.

“Raw natural gas” refer to unprocessed natural gas, which may contain natural gas liquids (e.g., condensate, natural gasoline, liquified petroleum gas), water, and other impurities (e.g., nitrogen, carbon dioxide, hydrogen sulfide, helium).

“Hydration” and “host-guest complexing” in reference to a phase change herein refer to the formation of a different phase by the uptake of water or the formation of a clathrate or clathrate-like structure.

A “clathrate” refers to a compound in which molecules of one substance are physically trapped within the crystal structure of another substance.

“Supercritical conditions” refers to the temperature and pressure conditions in which a material exists in a supercritical phase. A “supercritical phase” refers to a fluid at a temperature and pressure that is greater than its critical temperature and pressure. The critical temperature of a substance is the temperature above which vapor of a substance cannot be liquified, no matter how much pressure is applied. The critical pressure of a substance is the pressure required to liquify a gas at the critical temperature

“Supercool” or “subcool” refers to cooling of a substance in a first phase to a temperature that is below the equilibrium phase change temperature to a second phase (e.g., dew point or freezing point), for a given pressure, wherein the substance does not transition to the second phase (e.g., cool below the dew point without the substance becoming a liquid, or cool below the freezing point without the substance becoming a solid).

### Surface Modifications

Surface modifications are provided herein that maintain spherical or substantially spherical droplets at sizes below the homogeneous nucleation critical radius, thereby resulting in a surface temperature at the onset of nucleation that is below the dew point. In some embodiments, water will not condense (e.g., form a liquid phase wherein sufficient material is aggregated such that it can be readily observed, or is large enough to measure a contact angle) on modified surfaces as described herein even when the surface temperature is below the equilibrium dew point.

In some embodiments, the surface modification is in the form of a barrier coating, a conversion coating, or a combination thereof. In one embodiment, the surface modification is a nanostructured surface modification. The surface modification results in a reduction of free surface energy, thereby causing droplets to become more spherical at sizes below the critical nucleation radius.

In certain embodiments, the surface modification includes a metal oxide or polymer. In one embodiment, the surface modification includes a polymer that contains alkyl or fluoroalkyl monomer units. In one embodiment, the surface modification includes a metal oxide layer that is created through deposition or conversion. In one embodiment, the surface modification is terminated with alkyl or fluorinated compound(s).

In some nonlimiting embodiments, the surfaces are modified with nanostructured mixed metal oxides, for example, by dipping a cleaned substrate in a mixture of 0.25M to 1 M Group II or transition metal salts, such as zinc nitrate, magnesium nitrate, and/or manganese sulfate, and 0.1M to 2M of an amine, such as hexamine or urea, at a solution temperature of about 40° C. to about 90° C. for a duration of about 5 minutes to about 2 hours. The sample can then be removed from the solution, rinsed, and baked at a temperature from about 100° C. to about 600° C. The sample can then be dipped into a dilute solution of a hydrophobic chemistry, for example, stearic acid in hexane, hexadecylphosphonic acid in isopropanol, or a solution containing perfluorodecyltriethoxysilane in ethanol for about 5 minutes to about 120 minutes. The substrate can then be removed and allowed to dry in an oven at about 105° C. for about 1 hour.

Nonlimiting embodiments of surface modifications that may be used herein are described, for example, in WO2018/053452 and WO2018/053453, which are incorporated herein by reference in their entireties.

### Applications of Use

In applications of use of modified surfaces as described herein, the surface increases the energy barrier to a phase change from a first phase to a second phase.

In some embodiments, the first phase is subcooled below the equilibrium phase transition value to the second phase and still exists as the first phase. For example, the first phase may be subcooled by about 0.25° C. to about 10° C., about 0.25° C. to about 1° C., about 0.5° C. to about 2° C., about 1° C. to about 5° C., about 3° C. to about 5° C., or about 5° C. to about 10° C. below the equilibrium phase transition value to the second phase and still exist as the first phase. In some embodiments, the first phase may be subcooled by greater than any of about 0.25° C., 0.5° C., 1° C., 2° C., 3° C., 4° C., 5° C., 6° C., 7° C., 8° C., 9° C., or 10° C. below the equilibrium phase transition value to the second phase and still exist as the first phase.

In some embodiments, the energy barrier to phase change from the first phase to the second phase is about 50% to about 99%, about 50% to about 70%, about 60% to about 80%, about 70% to about 90%, about 80% to about 90%, about 85% to about 95%, or about 95% to about 99% of the homogeneous nucleation energy. In some embodiments, the energy barrier may be greater than any of about 50%, 60%, 70%, 80%, 90%, 95%, or 99% of the homogenous nucleation barrier.

In some embodiments, nucleation is suppressed at a supercool of greater than about 5° C.

In one embodiment, the first phase consists or consists essentially of water vapor and the second phase is water liquid or ice. In another embodiment, the first phase is air containing water vapor and the second phase is liquid water or ice. In another embodiment, the first phase is liquid water and the second phase is water ice. In another embodiment, the first phase consists or consists essentially of air and water vapor and the second phase is water ice. In another embodiment, the first phase is carbon dioxide vapor and the second phase is carbon dioxide ice (dry ice). In another embodiment, the first phase is a liquid and the second phase is a condensation of a solid phase. In another embodiment, the first phase is a metal vapor and the second phase is condensed metal vapor.

In some embodiments of the applications of use described herein, a condensed droplet at the critical radius of formation exists on the modified surface in a dewetted state (i.e., Cassie-Baxter state).

Heat exchanger/heat transfer methods of use include the use of the materials herein to promote heat exchange and reduce the temperature at which condensation is observed. Further, the use of these materials on heat exchangers to reduce the temperature at which frosting occurs provides a benefit over traditional materials by increasing the operational running time, minimizing the impact that ice formation has on heat transfer performance, and increasing the operating range of the system. Heat exchangers that include the materials described herein, e.g., as a coating or layer on one or more surface(s) of the heat exchanger, wherein the surface material provides the functional properties of promoting heat exchange and reducing the temperature at which condensation is observed and/or the temperature at which frosting occurs, are also provided.

Glass window, mirror, or lens applications of use include the use of the surface modifications described herein to prevent unwanted condensation for viewing applications. Further, the method of use may include materials that can be patterned and used to provide a decorative pattern on a glass, for example patterning the outside of a water, wine or beer glass such that condensation occurs in an aesthetically pleasing manner. Glass, mirrors, and lenses that include the materials described herein, e.g., as a coating or layer on the surface of the glass, mirror, or lens, wherein the surface material provides the functional property of preventing undesired condensation, are also provided, including, in some embodiments, a surface coating or layer in a decorative pattern.

Computer case/rack cooling applications of use include the use of the surface modifications described herein to prevent undesirable condensation related damage to electronics. Further, the method of use may include the application of surface modifications described herein to provide an additional operational barrier to the formation of condensate on the coldest components of a computer case or rack. The increased driving force required for condensation results in additional operational margin of safety. Computer cases and/or racks that include the surface modifications described herein, e.g., as a coating or layer on a surface of the computer case or rack, wherein the surface material provides the functional property of preventing undesired condensation which could cause damage to electronics, are also provided.

Gas vaporizer applications of use includes the use of the surface modifications described herein to prevent undesirable condensation and frost on a vaporizer heat exchanger, such as, but not limited to, a liquid nitrogen exchanger. The formation of condensate and ice on the vaporizer heat exchanger limits the effectiveness of the heat exchanger and therefore either reduces the available flow of expanded gas or requires a larger heat exchanger. A secondary benefit of the use of surface modifications as described herein is the improved ability to shed ice which has formed on the exchanger. Gas vaporizers that include the surface modifications described herein, e.g., as a coating or layer on a surface of the gas vaporizer, e.g., on a surface of a vaporizer heat exchanger, such as a liquid nitrogen exchanger, wherein the surface material provides the functional property of preventing undesired condensation and/or frost, are also provided.

Antifouling condensation applications of use include the use of the surface modifications described herein to prevent undesirable condensation on a vaporizer device. In such an embodiment, the prevention of condensation is intended to prevent fouling and deposition of heavier components and natural oils. One example would be glycol based e-cigarette or other similar devices. Additional anti-fouling applications include nozzle based thermal printers and devices. Vaporizers that include the surface modifications described herein, e.g., as a coating or layer on a surface of the vaporizer, such as an e-cigarette or similar device, or the nozzle of a thermal printer or device, wherein the surface material provides the functional property of preventing condensation to prevent fouling and/or deposition of heavy components and oils, are also provided.

Engine/nozzle icing applications of use include the prevention of carbon dioxide condensation in engine and combustion nozzle applications. Combustion engines and nozzles that include surface modifications as described herein, e.g., as a coating or layer on a surface of the engine or nozzle, wherein the surface material provides the functional property of preventing carbon dioxide condensation, are also provided.

Hydrate and clathrate prevention applications of use include the prevention of water and gas hydrates formation during the processing of industrial gases and liquids in process equipment, such as compressed natural gas production, or methane clathrate deposition in high pressure drilling applications. Processing equipment for industrial gases and liquids that include the surface modifications described herein, e.g., as a coating or layer on a surface of the processing equipment, wherein the surface material provides the functional property of preventing water and gas hydrate formation, are also provided.

Metal vapor condensation prevention applications of use include the prevention of metal condensation during operation of metal vapor lighting, or advanced lithography applications where uniformity and prevention of deposition is critical to precise operation. Metal vapor lighting and lithography equipment that include the surface modifications described herein, e.g., as a coating or layer on a surface of the equipment, wherein the surface material provides the functional property of preventing metal condensation during operation of the equipment, are also provided.

The following examples are intended to illustrate, but not limit, the invention.

### EXAMPLES

### Example 1

Aluminum plates were modified with nanostructured mixed metal oxides by dipping a cleaned aluminum plate in a mixture of 0.25M to 1 M Group II or transition metal salts, such as zinc nitrate, magnesium nitrate and/or manganese sulfate, and 0.1M to 2M of an amine, such as hexamine or urea, at a solution temperature of 40° C. to 90° C. for a duration of 5 minutes to 2 hours. The sample was then removed from the solution, rinsed, and baked at a temperature from 100° C. to 600° C. The sample was then dipped into a dilute solution of stearic acid in hexane, hexadecylphosphonic acid in isopropanol, or a solution containing perfluorodecyltriethoxysilane in ethanol for 30 to 90 minutes. The sample was then removed and allowed to dry in a 105° C. oven for 1 hour.

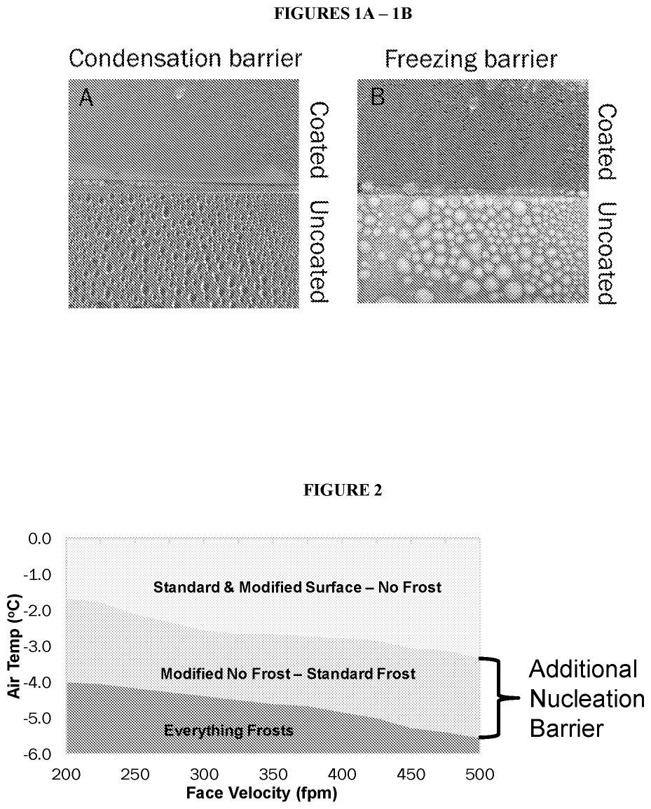

The surface modified aluminum plates were filmed through a microscope while placed on a surface and cooled to −10° C. Condensation was observed to start on the uncoated sample much sooner and the coated sample started condensing much later as the surface temperature was reduced below the dew point (FIG. 1A). As the experiment continued, the uncoated sample nucleated the water into ice while the coated sample remained liquid water (FIG. 1B). This example shows a nucleation barrier to both vapor>liquid and liquid>solid transitions.

### Example 2

A heat exchanger surface was modified with a nucleation barrier coating as described in Example 1. An icing test was performed wherein the heat exchanger and the air were simultaneously cooled to a temperature below 0° C. in a closed loop wind tunnel to determine the onset of frosting. FIG. 2 shows the result in the test where the unmodified heat exchanger started forming ice and the surface modified heat exchanger did not form ice (the middle band, labeled as a nucleation barrier). This surface modification decreased the temperature of nucleation by about 2° C. in comparison to the control unmodified surface.

### Example 3

As shown in FIG. 3, closed-loop air conditioner system circulates room air at 30° C., 50% relative humidity (RH) through a server rack where it is heated to about 40° C., 27% RH. The air is immediately passed through a liquid air heat exchanger wherein the coolant enters at 20° C.

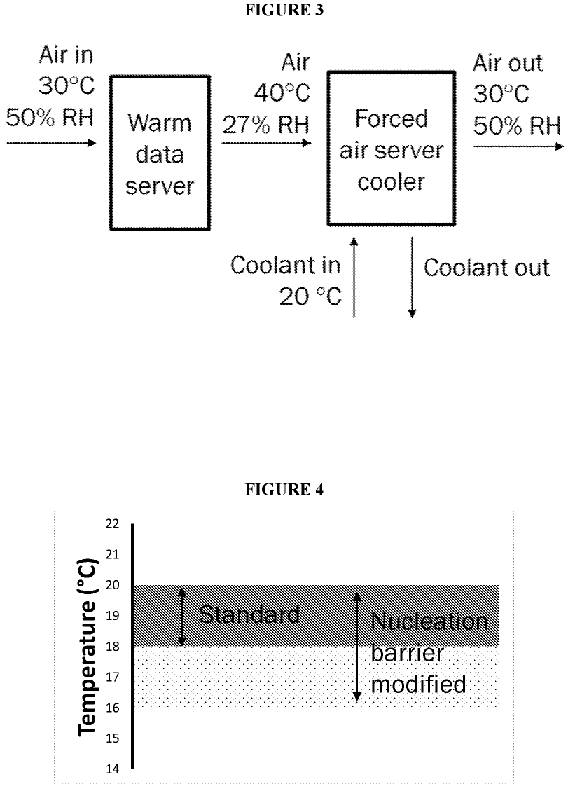

As shown in FIG. 4, the air both entering and leaving the server rack has an equilibrium dew point of 18° C. Using an unmodified heat exchanger, this leaves 2° C. error in the control system to prevent the condensation that could drip on the server racks. By adding a condensation nucleation barrier to the heat exchanger, an energy barrier is added and condensation is not observed until 16° C., effectively doubling the safety margin and adding further protection to equipment.

### Example 4

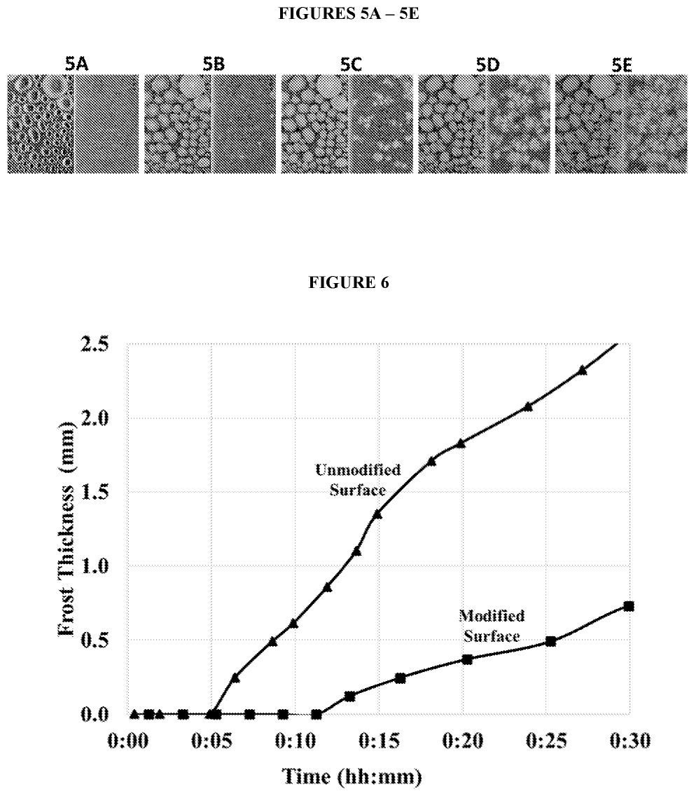

Two 3003 aluminum plates, one modified and one unmodified control, were thermally coupled side-by-side onto a cold plate cooled to −10° C. The air temperature was about 22° C. and 40% humidity. This air was passed across the surface of these plates through an 8 ft long wind tunnel with a face velocity of about 2 m/s. The surface was modified with a procedure similar to that in Example 1. The cold plate was frosted for 1 hour and defrosted for 10 minutes prior to starting this experiment by turning on and off the cold plate. The image progression in FIGS. 5A-5E shows the phase change as time progresses from at about the 30 second point in FIG. 5A to about the 1 hour point at FIG. 5E. The modified surface delays the phase change into water ice from liquid water and slows down its formation thereafter. After 1 hour, there is still liquid water on the modified sample, whereas in the unmodified sample, it is completely frozen.

### Example 5

An unmodified aluminum plate and an aluminum plate modified according to the method described in Example 1 were placed onto a thermoelectric cold plate with a surface temperature set to about −5° C. The air was passed across the plate inside a wind tunnel with a face velocity of 1.5 m/s and an air temperature and relative humidity of 25° C. and 40%, respectively. The ice thickness was measured using a microscope, viewing the cross-section as a function of time. A plot of the ice thickness as a function of time is depicted in FIG. 6. On the modified aluminum plate, the onset of frosting as measured by the microscope began at 11 minutes, taking 6 minutes longer to form frost than the unmodified plate. This barrier delay in phase change continued throughout the duration, resulting in a 3 mm thinner layer of ice after 2 hours. The ice thickness on the unmodified plate was 7 mm, whereas ice thickness on the modified plate was 4 mm.

### Example 6

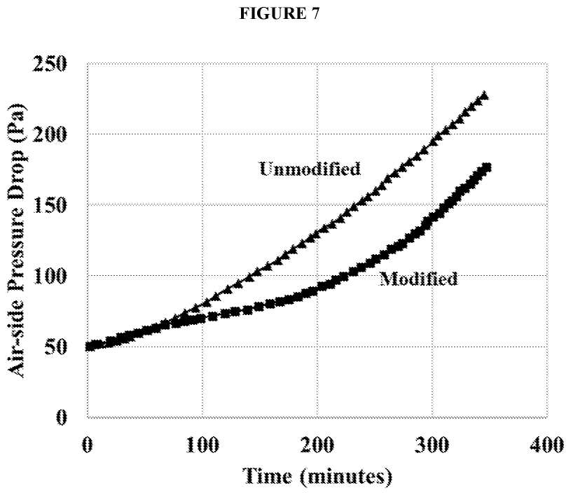

An aluminum fin, stainless steel tube heat exchanger with parallel fins at 4 fins per inch was modified with a phase change barrier coating as described in Example 1 and tested in a wind tunnel relative to an unmodified heat exchanger. The glycol refrigerant temperature was set to −4° C. and was passed through the tube side of the coil at a flow rate of about 800 grams per second. Air was passed across the fin side of the coil at a face velocity of 3 m/s and an inlet temperature and humidity of 2° C. and 83%, respectively. The heat transfer capacity and air side pressure drop of the coil were monitored for 5 hours. On the unmodified coil, water was condensed out of the air and it immediately froze on the surface, which was at a temperature below the freezing point of water. This caused the pressure drop to increase. On the heat exchanger with fins modified with the phase change barrier coating, it took much longer for the liquid water on the surface to freeze, resulting in the condensed water from the air draining from the coil for an extended period. After 5 hours, the air-side pressure drop on the unmodified coil was about 195 Pa and the air-side pressure drop on the modified coil was about 140 Pa. This delay in the liquid to solid phase change resulted in an improvement of about 30% in airside pressure drop. A plot of the air-side pressure-drop as a function of time is shown in FIG. 7.

Although the foregoing invention has been described in some detail by way of illustration and examples for purposes of clarity of understanding, it will be apparent to those skilled in the art that certain changes and modifications may be practiced without departing from the spirit and scope of the invention, which is delineated in the appended claims. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

1.-57. (canceled)

58. A method for preventing or delaying the onset of a phase change on a surface, said method comprising:
providing a modified surface that comprises a surface modification, wherein the modified surface increases the energy barrier to a phase change or driving force required for a phase change from a first phase to a second phase for a substance that is in contact with the modified surface, in comparison to an unmodified surface that is identical to the modified surface with the exception that the unmodified surface does not comprise the surface modification; and
contacting a fluid stream that comprises a substance in at least one first phase comprising the substance in a vapor phase and/or in a liquid phase with said modified surface under environmental conditions at which phase change to a second phase would occur on the unmodified surface,
wherein said phase change is prevented or delayed on said modified surface in comparison to the unmodified surface.

59. The method of claim 58, wherein said at least one first phase comprises a vapor phase comprising water vapor, wherein said second phase comprises a liquid phase comprising water, and wherein said prevention or delay of phase change comprises prevention or delay of condensation of said vapor to form a liquid on said surface.

60. The method of claim 58, wherein said at least one first phase comprises a vapor phase comprising water, wherein said second phase comprises a solid phase comprising water, wherein said vapor condenses on said surface to form a condensate, and wherein said prevention or delay of phase change comprises prevention or delay of solidification of said condensate to form a solid on said surface.

61. The method of claim 58, wherein said at least one first phase comprises a vapor phase comprising water and a liquid phase, wherein said second phase comprises a liquid phase comprising water, and wherein said prevention or delay of phase change comprises prevention or delay of condensation of said vapor to form a liquid on said surface.

62. The method of claim 58, wherein said at least one first phase comprises a vapor phase comprising water and a liquid phase, wherein said second phase comprises a solid phase comprising water, wherein said surface comprises condensate from said vapor and/or liquid, and wherein said prevention or delay of phase change comprises prevention or delay of solidification of said condensate and/or said liquid to form a solid on said surface.

63. The method of claim 58, wherein said at least one first phase comprises a vapor phase, wherein said second phase comprises a solid phase, and wherein said prevention or delay of phase change comprises prevention or delay of solidification of said vapor to form a solid on said surface.

64. The method of claim 63, wherein said vapor is water vapor, said solid is water frost or ice, and wherein said prevention or delay of phase change comprises prevention or delay of solidification of said water vapor to form water frost or ice on said surface.

65. The method of claim 63, wherein said vapor is CO₂ gas, said solid is frozen CO₂, and the prevention or delay of phase change comprises prevention or delay of solidification of said CO₂ gas to form frozen CO₂ on the surface.

66. The method of claim 58, wherein said modified surface is subcooled below the equilibrium phase transition value of said first phase to said second phase and said substance still exists in the first phase.

67. The method of claim 66, wherein said modified surface is subcooled by greater than about 0.25° C. below the equilibrium phase transition value of said first phase to said second phase and said substance still exists in the first phase.

68. The method of claim 58, wherein the energy barrier to phase change from said first phase to said second phase is greater than about 50% of the homogenous nucleation energy.

69. The method of claim 58, wherein said phase change from said first phase to said second phase comprises nucleation of said substance on said surface modification, and wherein the surface modification comprises a barrier coating, a conversion coating, or a combination thereof.

70. The method of claim 69, wherein the surface modification where nucleation occurs is nanostructured.

71. The method of claim 69, wherein the surface modification where nucleation occurs comprises a metal oxide or a polymer

72. The method of claim 71, wherein the surface modification where nucleation occurs comprises one or more terminal alkyl or fluorinated compound(s).

73. A modified surface that comprises a surface modification, wherein the modified surface increases the energy barrier to or driving force required for a phase change from a first phase to a second phase for a substance that is in contact with the modified surface, in comparison to an unmodified surface that is identical to the modified surface with the exception that the unmodified surface does not comprise the surface modification, wherein the onset of said phase change is prevented or delayed in comparison to the unmodified surface.

74. A heat exchanger or heat transfer surface or a glass, window, mirror or lens comprising a modified surface according to claim 73, wherein the onset of said phase change from the first phase to the second phase is prevented or delayed in said heat exchanger or heat transfer surface or on said glass, window, mirror or lens, in comparison to a heat exchanger or heat transfer surface or glass, window, mirror or lens that does not comprise the modified surface.

75. A computer case or cooling rack comprising a modified surface according to claim 73, wherein the onset of said phase change from the first phase to the second phase is prevented or delayed on said computer case or cooling rack, in comparison to a computer case or cooling rack that does not comprise the modified surface, wherein said phase change comprises condensation of water, and wherein said modified surface prevents or reduces condensation related damage to electronics housed therein in comparison to an unmodified surface.

76. A gas vaporizer or gas vaporizer heat exchanger comprising a modified surface according to claim 73, wherein the onset of said phase change from the first phase to the second phase is prevented or delayed on said gas vaporizer, wherein said substance is water and said phase change comprises condensation of water and/or formation of frost, and wherein said modified surface prevents or reduces condensation and/or frost formation in said gas vaporizer or gas vaporizer heat exchanger in comparison to an unmodified surface.

77. The method of claim 58, wherein the modified surface is on metal vapor lighting or advanced lithography equipment, wherein the substance is a metal, wherein the phase change comprises metal vapor condensation, and wherein the modified surface prevents or reduces metal vapor condensation during operation of said metal vapor lighting or advanced lithography equipment.
